(19) United States
(12) Patent Application Publication
(10) Pub. No.: US 2012/0181299 A1
(43) Pub. Date: Jul. 19, 2012

(54) PIN DISPENSING SYSTEM AND METHOD

(75) Inventors: Jilene A. Repp, Hartland, WI (US); David H. Weaver, West Bend, WI (US)

(73) Assignee: June Tailor, Inc.

(21) Appl. No.: 13/006,043

(22) Filed: Jan. 13, 2011

(51) Int. Cl. B65D 83/02; B23P 11/00; B65G 59/00

(52) U.S. Cl. 221/200; 221/289; 221/286; 221/277; 221/258; 221/268; 221/282; 221/276; 29/428

(57) ABSTRACT

A pin dispensing apparatus including a dispenser configured to present a pin to a user, a transfer member configured to convey the pin to the dispenser, and a delivery mechanism configured to provide the pin to the transfer member.

### FIELD

The present invention relates generally to the field of dispensing devices. More specifically, the present invention relates to pin dispensing devices.

### BACKGROUND

Pins are often used as fasteners to temporarily hold two or more objects together. Pins are also commonly used in sewing, quiltmaking, etc., to temporarily join two pieces of fabric prior to more permanent stitching. For example, in the process of making a large quilt, a quiltmaker may use hundreds of pins.

Pins are relatively small, thus, storing pins in a pile is considered an inefficient form for selecting and grasping a pin. Furthermore, pins have a sharp end, thus storing pins in a pile would tend to poke or prick a user attempting to select and grasp a pin. To organize and safely store pins, sewers and quilters often use pin cushions. Pin cushions come in a variety of shapes and sizes. Many are made of penetrable materials, such as polystyrene or fabric wrapped balls of scrap material, batting, or other stuffing, and are traditionally configured to resemble a tomato or other fruit. Other pin cushions use a strong magnet to hold pins in place.

### SUMMARY

One embodiment of the invention relates to a pin dispensing apparatus including a dispenser configured to present a pin to a user, a transfer member configured to convey the pin to the dispenser, and a delivery mechanism configured to provide the pin to the transfer member.

Another embodiment of the invention relates to a pin dispensing apparatus including at least one transfer member, which has a first end, a second end, and at least one edge. The edge is disposed substantially between the first and second ends and defines a chute. The pin dispensing apparatus also includes a dispenser configured to present a pin to a user and disposed substantially near the first end. The dispenser includes an actuator and a return mechanism configured to urge the actuator towards the presenting position. The actuator is movable between a presenting position and a loading position and configured to liftably engage a pin head. The transfer member is inclined such that a pin head slidably engaged on the at least one edge will gravitationally translate from the second end towards the first end.

Another embodiment of the invention relates to a pin dispensing apparatus including a base, a drum coupled to the base for rotation about an axis and configured to contain a supply of pins, an elongated transfer member having a first end and a second end, and a dispenser disposed proximate the second end of the transfer member and configured to receive pins from the transfer member and move the pins to a presenting position for easy access by a user. As shown, the first end is disposed at least partially within the drum and configured to receive pins from the drum.

Another embodiment of the invention relates to a method for manufacturing a pin dispensing apparatus including providing a dispenser configured to present a pin to a user, providing a transfer member configured to convey the pin to the dispenser, and providing a delivery mechanism configured to provide the pin to the transfer member.

Alternative exemplary embodiments relate to other features and combinations of features as may be generally recited in the claims.

### BRIEF DESCRIPTION OF THE DRAWINGS

FIG. 1A is a perspective view of a pin dispensing apparatus, according to an exemplary embodiment.

FIG. 1B is a perspective view of a pin dispensing apparatus including a cover, according to an exemplary embodiment.

FIG. 2 is an exploded perspective view of a pin dispensing apparatus, according to an exemplary embodiment.

FIG. 3 is a perspective view of a front half of a drum of a pin dispensing apparatus, according to an exemplary embodiment.

FIG. 4 is a perspective view of a back half of a drum of a pin dispensing apparatus, according to an exemplary embodiment.

FIG. 5 is a perspective view of a portion of a transfer mechanism and a dispenser of a pin dispensing apparatus, according to an exemplary embodiment.

FIG. 6 is a top view of a portion of a transfer mechanism and a dispenser of a pin dispensing apparatus, according to an exemplary embodiment.

FIG. 7 is a side view of a portion of a transfer mechanism and a dispenser of a pin dispensing apparatus, according to an exemplary embodiment.

FIG. 8 is a perspective view of a plunger of a pin dispensing apparatus, according to an exemplary embodiment.

FIG. 9 is a perspective view of a base of a pin dispensing apparatus, according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

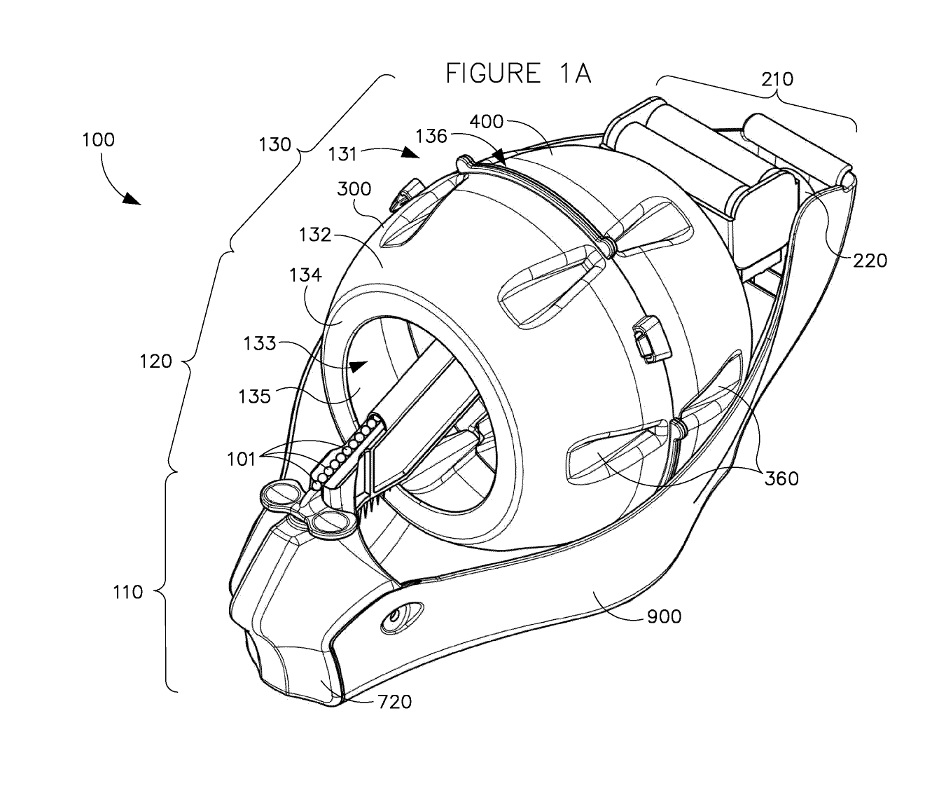

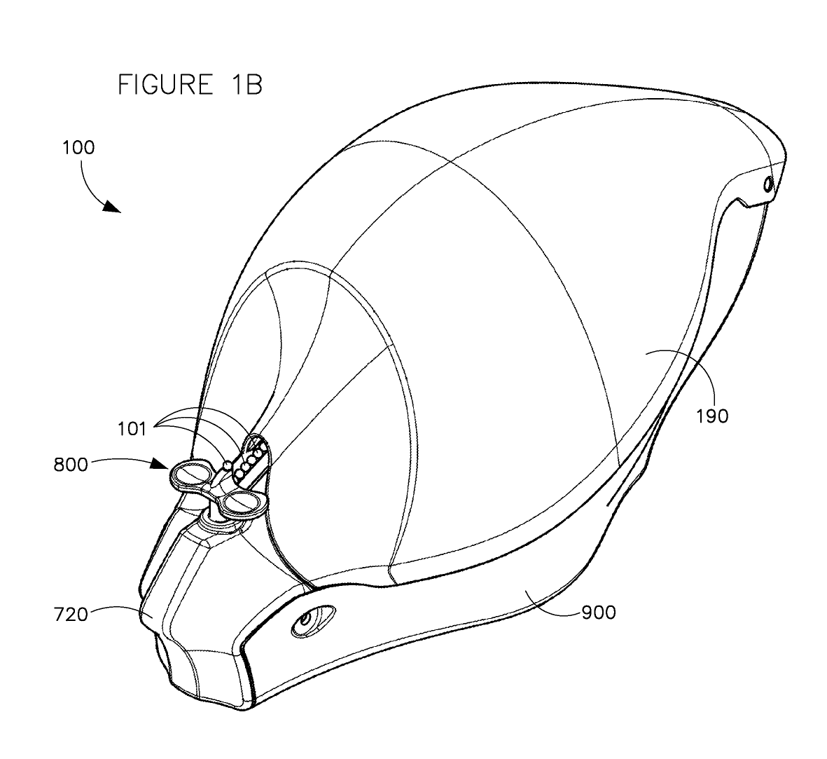

Referring to FIG. 1A, a perspective view of a pin dispensing apparatus, such as system 100, is shown according to an exemplary embodiment. As shown, system 100 includes a dispenser 110 configured to present a pin 101 to a user, a transfer member 120 configured to convey pins 101 to dispenser 110, and a delivery mechanism 130 configured to successively, provide pins 101 to the transfer member 120. In one embodiment, system 100 includes a base 900, which supports dispenser 110, transfer member 120, and the delivery mechanism 130. In one embodiment, system 100 includes a cover 190 (shown in FIG. 1B) coupled to base 900. Dispenser 110 is configured to present a steady supply of pins to a user. Pins are commonly used by quilters, sewers, and the like and come in a variety of shapes and sizes. It is generally understood that a pin includes a head, which is located at the end of a shank. The head may have a variety of shapes and sizes. The pin head is configured to be grasped by a user's fingers and is often spherical (but may have other shapes). The pin shank is configured such that the end opposite the head may be inserted into or through a portion of fabric.

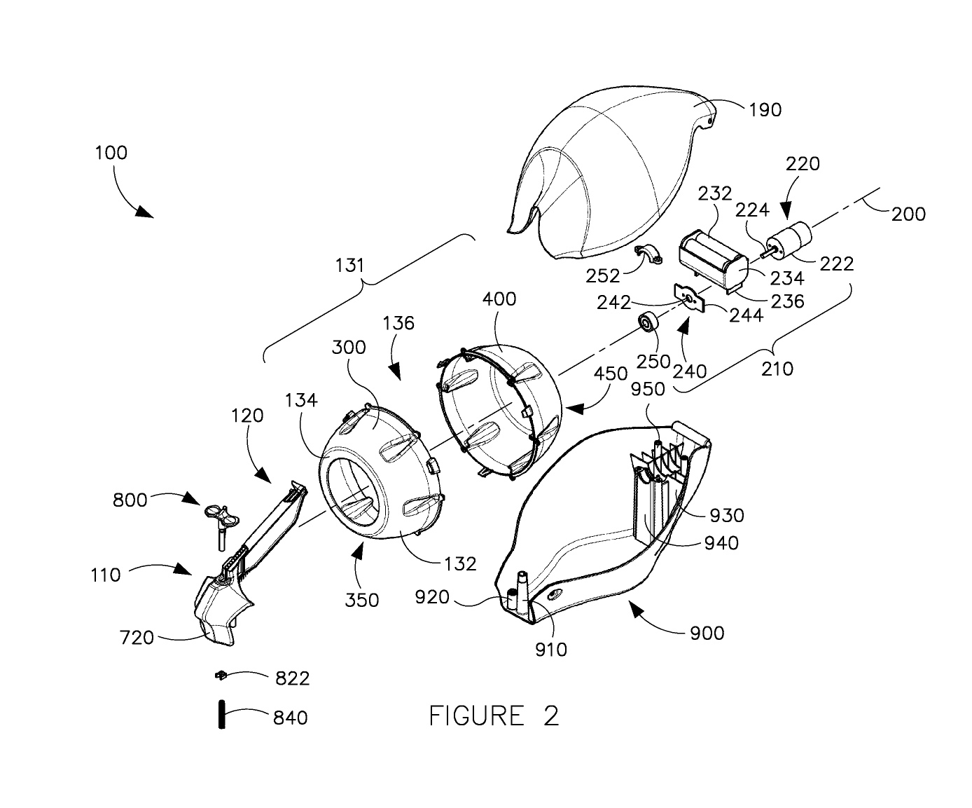

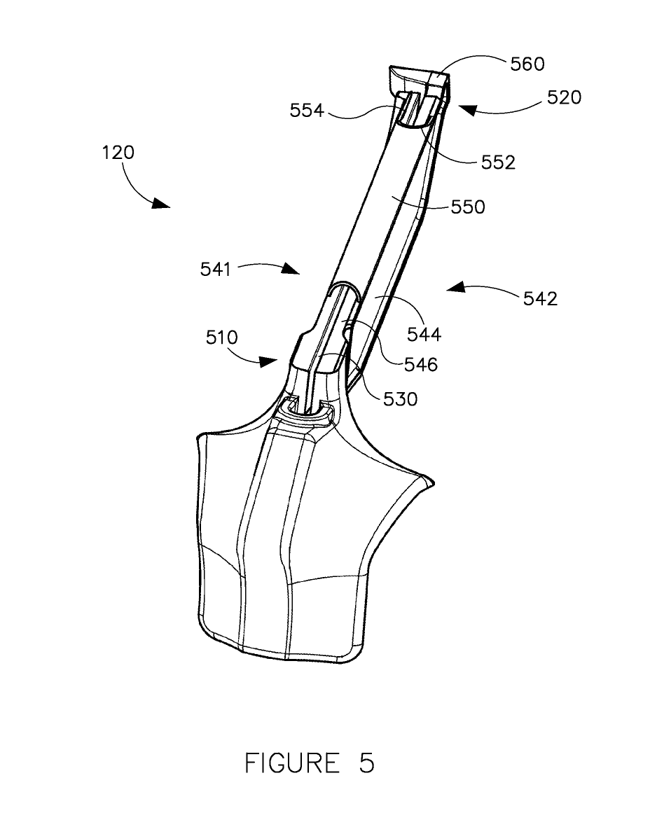

Referring to the center portion of FIG. 1A, a perspective view of delivery mechanism 130 is shown according to an exemplary embodiment. As shown, delivery mechanism 130 includes a housing, such as drum 131. Drum 131 may be made of metal, plastic, or other suitable rigid material. In one embodiment, drum 131 is made of polypropylene. In another embodiment, drum 131 is made of acrylonitrile butadiene styrene (ABS). Drum 131 is shown to include at least one sidewall, such as drum surface 132, which defines a cavity, such as chamber 133. Drum surface 132 has a first end 134 which defines an aperture 135. Drum 131 also has an axis of rotation 200 (shown in FIG. 2), which is shown as substantially perpendicular to a plane defined by aperture 135. Drum 131 is configured to receive a supply of pins. In one embodiment, drum 131 is configured such that a user may pour, drop, or otherwise load one or more pins into chamber 133 through aperture 135. As such, the pins received into drum 131 may be disorganized. As will be further described, drum 131 is configured to provide a supply of pins to transfer member 120 and, more particularly, to provide pins to a chute, such as channel 530 (see FIG. 5).

Referring further to FIG. 1A, in the embodiment shown, drum 131 includes a first half, shown as front half 300, coupled to a second half, shown as back half 400, at a midsection 136. According to the illustrated embodiment, front half 300 and back half 400 are releasably coupled, and drum 131 is substantially cylindrical and substantially barrel-shaped.

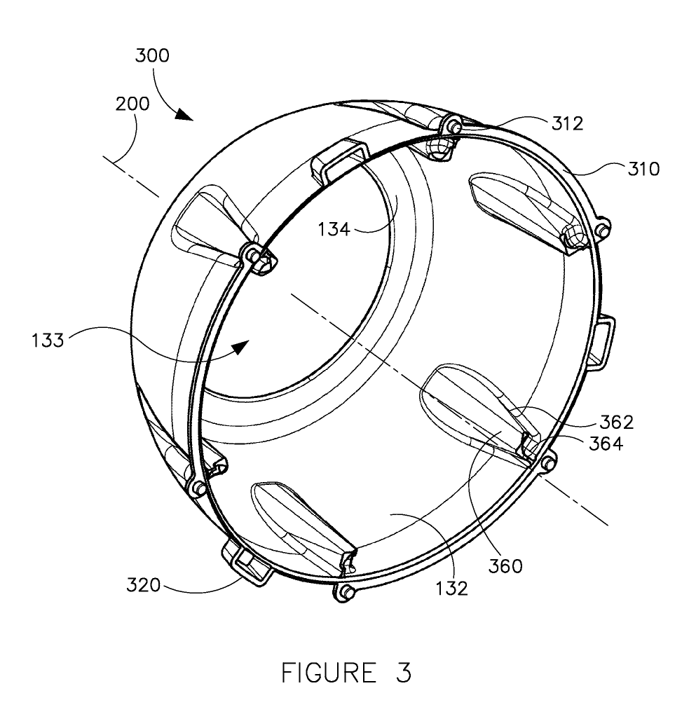

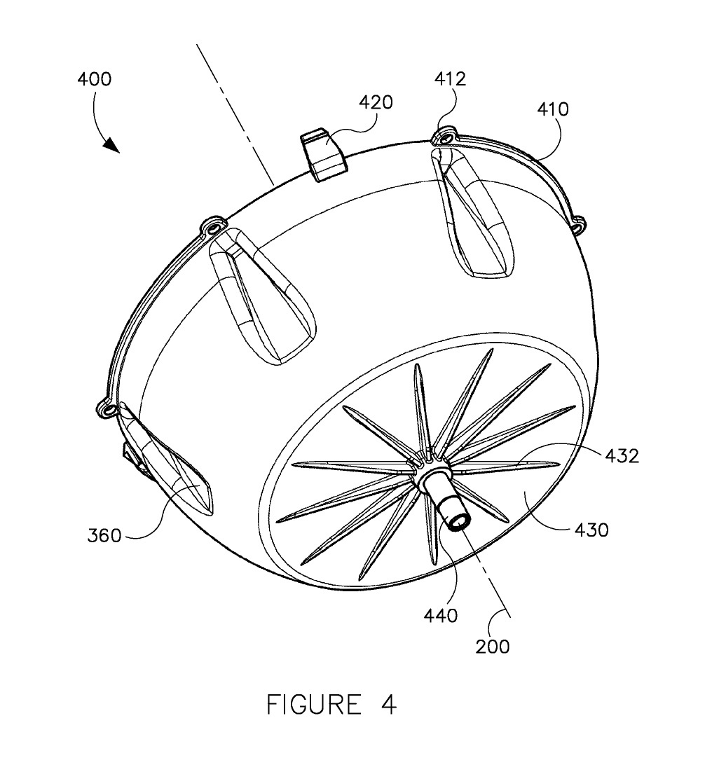

Referring to FIGS. 3 and 4, perspective views of front half 300 and back half 400, respectively, are shown according to an exemplary embodiment. In the embodiment shown, front half 300 supports at least one first flange 310, which supports at least one post 312. Back half 400 supports at least one second flange 410, which supports at least one eyelet 412 configured to receive post(s) 312. In various embodiments, the coupling of post(s) 312 and eyelet(s) 412 may be a snap fit, a press fit, threaded engagement, or such other fit sufficient to hold front half 300 and back half 400 together. In another embodiment, the fit between post(s) 312 and eyelet(s) 412 is sufficient to transfer torque from the back half 400 to the front half 300. As shown, back half 400 supports at least one tab 420. Front half 300 supports at least one retainer 320, which is configured to receive tab 420. Tab(s) 420 and retainer(s) 320 are intended to couple front half 300 and back half 400 such that a pin located in drum 131 will not exit chamber 133 through midsection 136.

Referring to FIG. 4, in the embodiment shown, drum 131 includes a second end, shown as closed end 430, opposite the first end 134. In the embodiment shown, closed end 430 is coupled to a driveshaft 440. As shown, closed end 430 supports at least one rib 432 (shown by way of example as a plurality of ribs that extend or radiate from driveshaft 440). Ribs 432 are configured to transfer torque from driveshaft 440 to drum 131, and ribs 432 are configured to support driveshaft 440 to provide a relatively durable and robust design.

As shown in FIG. 2, a smaller cross-section 350 of drum 131 is located near end 134. A larger cross-section of drum 131 is located near midsection 136. Another smaller cross-section 450 is located near the closed end of drum 131. The smaller and larger cross-sections are substantially perpendicular to axis of rotation 200. In the embodiment shown, the differential in cross-section between the ends of drum 131 and midsection 136 creates sufficient slope of drum surface 132 that pins 101 disposed in drum 131 tend to slide towards midsection 136 by force of gravity.

Returning to FIG. 3, in the embodiment shown, drum 131 includes at least one protrusion, such as lug 360. The protrusion(s) may be of various shapes and sizes, having linear or non-linear, concave or convex surfaces. Lug 360 is shown disposed on drum surface 132 and extending into chamber 133. As shown, lug 360 is a molded feature of drum surface 132 and forms an approximate “bow-tie” shape when front half 300 and back half 400 are assembled (see FIG. 1A). Lug 360 includes an inclined surface 362 configured such that rotation of drum 131 about axis of rotation 200 urges a pin disposed in drum 131 axially toward midsection 136. In one embodiment, a plurality of lugs 360 are configured to load pins onto transfer member 120 when drum 131 is rotated. As shown, lug 360 includes a scoop 364 configured to lift a pin by its head. In various embodiments, scoop 364 is formed anywhere along lug 360, or scoop 364 may be formed at an end of lug 360, or a plurality of lugs may cooperate to lift a pin by its head. In the embodiment shown, scoop 364 on front half 300 cooperates with a corresponding scoop on a corresponding lug on back half 400 to lift a pin along midsection 136 during rotation of drum 131.

In one exemplary embodiment, rotation of the drum 131 is intended to load a supply of pins onto transfer member 120. According to a first aspect, rotation of drum 131 about axis of rotation 200 will cause lug 360 to come in contact with a pin located in a bottom position within drum 131. In the bottom position, inclined surface 362 is substantially vertical. As drum 131 continues to rotate, lug 360 will lift the pin to a side position. In the side position, inclined surface 362 is somewhat horizontal, but inclined such that the pin slides axially toward midsection 136. Scoop 364 engages a head of the pin. As drum 131 continues to rotate, lug 360 will lift the pin to a top position within drum 131. In the top position, inclined surface 362 has a sufficient vertical component that the pin falls through chamber 133 toward the bottom position and into (or onto) transfer member 120 as will be described in further detail. According to a second aspect, during rotation of the drum, gravity pulls a pin disposed in drum 131 down a slope of drum surface 132 to midsection 136. As drum 131 rotates about axis of rotation 200, scoop 364 engages a head of the pin. As drum 131 continues to rotate, scoop 364 lifts the pin to a top position. In the top position, the pin falls from scoop 364, through chamber 133 and into (or onto) transfer member 120 as will be described in further detail.

Referring to the bottom left portion of FIG. 2, an exploded perspective view of system 100, and FIG. 5, a perspective view of transfer member 120, transfer member 120 is shown according to an exemplary embodiment for receiving pins during rotation of drum 131 and sequentially delivering the pins to dispenser 110. Transfer member 120 may be made of metal, plastic, or other suitable rigid material. In one embodiment, transfer member 120 is made of polypropylene. In another embodiment, transfer member 120 is made of ABS. Transfer member 120 is shown to include a first end 510 disposed near dispenser 110, a second end 520 disposed opposite first end 510, and a chute or slide, such as channel 530, disposed substantially between first end 510 and second end 520. In one embodiment, channel 530 is configured to receive a pin shank. In one embodiment, transfer member 120 is elongated and is configured to convey a pin from second end 520 to first end 510 by a gravity feed. In various embodiments, second end 520 may be disposed at least partially within drum 131 and configured to receive pins from drum 131, second end 520 may be disposed within an upper portion of drum 131, and/or second end 520 may be disposed in chamber 133.

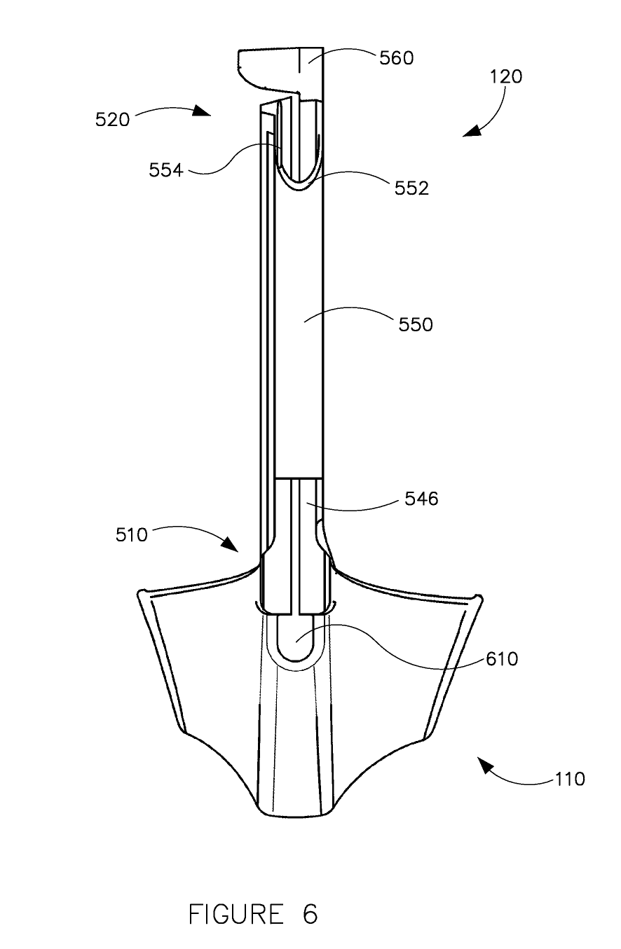

Referring further to FIGS. 5 and 6, transfer member 120 is shown to include a first side, such as left side 541, a second side, such as right side 542, a canopy 550, and channel 530. Right side 542 includes a web 544 and a flange 546, which forms an edge that at least partially defines channel 530, and left side 541 includes a web and a flange, which forms an edge that at least partially defines channel 530. The edge is configured to slidably engage a pin head for transfer to the dispenser. As shown in FIG. 1A, the flanges and the edges are inclined between dispenser 110 and delivery mechanism 130, such that a pin received at second end 520 of transfer member 120 will translate (e.g., slide) by gravitational force to first end 510 of transfer member 120. A subsequent pin received by transfer member 120 will translate to first end 510. If the previous pin has not been removed from the transfer member, the subsequent pin will remain with the previous pin, awaiting dispensing.

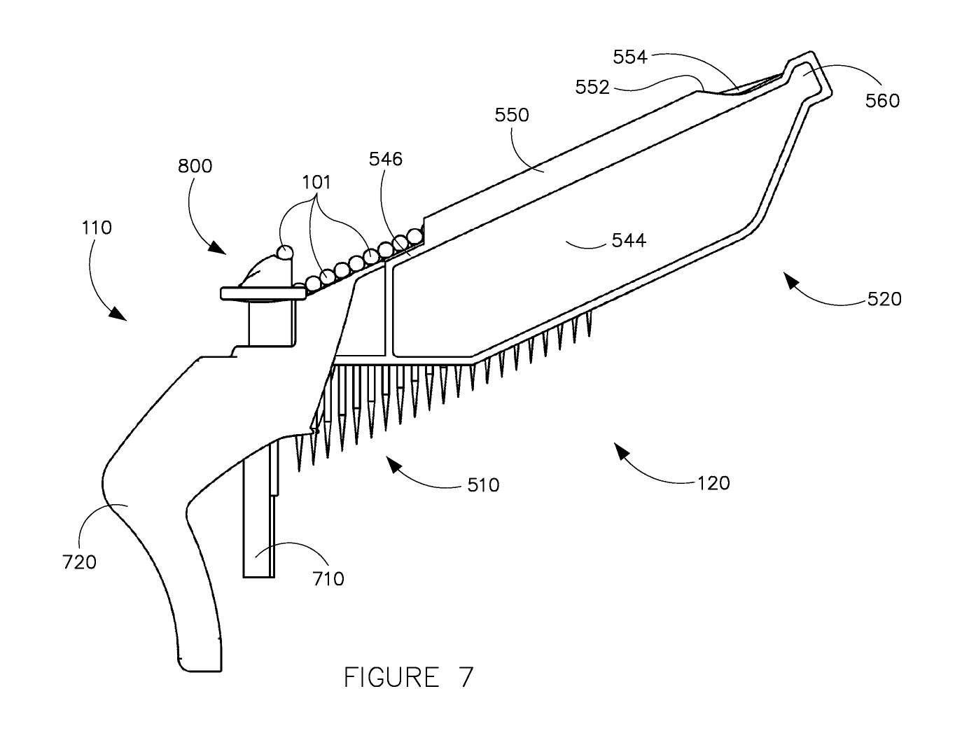

According to the exemplary embodiment shown, canopy 550 is coupled to left side 541 and right side 542 and serves as a spacer to support left side 541 and right side 542 at a predetermined distance apart. The predetermined distance is such that channel 530 is configured to receive a pin shank and such that the edges support a pin head. In the embodiment shown, canopy 550 covers a substantial length of transfer member 120. In alternate embodiments, the canopy may cover a greater or lesser length of the transfer member. In still other embodiments, transfer member 120 may include a plurality of shorter canopies. In one embodiment, canopy 550 is configured to divert a stray pin (i.e. a pin not properly received by the transfer member) off of transfer member 120 and to return the stray pin to delivery mechanism 130. In the embodiment shown, canopy 550 has an end 552 proximate second end 520 of transfer member 120 that is inclined relative to flange 546 (as shown in FIG. 7) and that is configured to deflect a stray pin off of flange 546. Left side 541 is shown to also include a structure 554 (e.g., rail, ramp, webbing, etc.) disposed near end 552. Structure 554 is coupled to canopy 550 and to flange 546 and is configured to deflect a stray pin off of flange 546.

According to the exemplary embodiment shown, left side 541 and right side 542 are coupled to dispenser 110 near first end 510, and transfer member 120 is cantilevered from dispenser 110. Alternatively, the transfer member may be supported by the base. As shown in FIG. 1A, second end 520 of transfer member 120 is located within drum 131 such that it may receive a pin from delivery mechanism 130 (e.g., that it may receive or intercept a pin falling through chamber 133, and/or that it may receive or intercept a pin falling from lug 360 through chamber 133). In the embodiment shown, right side 542 includes endcap 560 located near second end 520. Endcap 560 is configured to guide a pin falling through chamber 133 into channel 530. As shown, endcap 560 crosses a plane defined by channel 530. As shown in FIG. 7, a top of endcap 560 is raised above a plane defined by flange 546.

Referring to the bottom left of FIG. 2, an exploded perspective view of dispenser 110 is shown according to an exemplary embodiment. Dispenser 110 may be made of metal, plastic, or other suitable rigid material. In one embodiment, dispenser 110 is made of polypropylene. In another embodiment, dispenser 110 is made of ABS. According to one exemplary embodiment, dispenser 110 is configured to receive a pin from transfer member 120 and present the pin to a user in a one-pin-at-a-time manner. In one embodiment, dispenser 110 is configured to liftably engage a pin head and has a presenting position, a loading position, and a return mechanism. The return mechanism is configured to urge dispenser 110 towards the presenting position with a pin after dispenser 110 has been depressed towards the loading position to receive the pin. In one embodiment the return mechanism includes a biasing device, such as spring 840. Dispenser 110 is shown disposed substantially near first end 510 of transfer member 120 and includes an actuator, such as plunger 800, configured to liftably engage a pin.

According to the exemplary embodiment shown in FIG. 1A, dispenser 110 is coupled to base 900. As shown in FIGS. 6 and 7, dispenser 110 includes at least one support structure, such as column 710, configured to support dispenser 110. Column 710 may be releasably coupled to base 900. As shown, dispenser 110 also includes a passageway 610 configured to receive plunger 800. Passageway 610 may have a variety of shapes. In the embodiment shown, passageway 610 is U-shaped or C-shaped. Passageway 610 engages plunger 800 such that plunger 800 may slide longitudinally but has substantially limited rotation. Passageway 610 locates plunger 800 near first end 510 of transfer member 120. In the embodiment shown, passageway 610 locates plunger 800 adjacent and contiguous to first end 510 of transfer member 120.

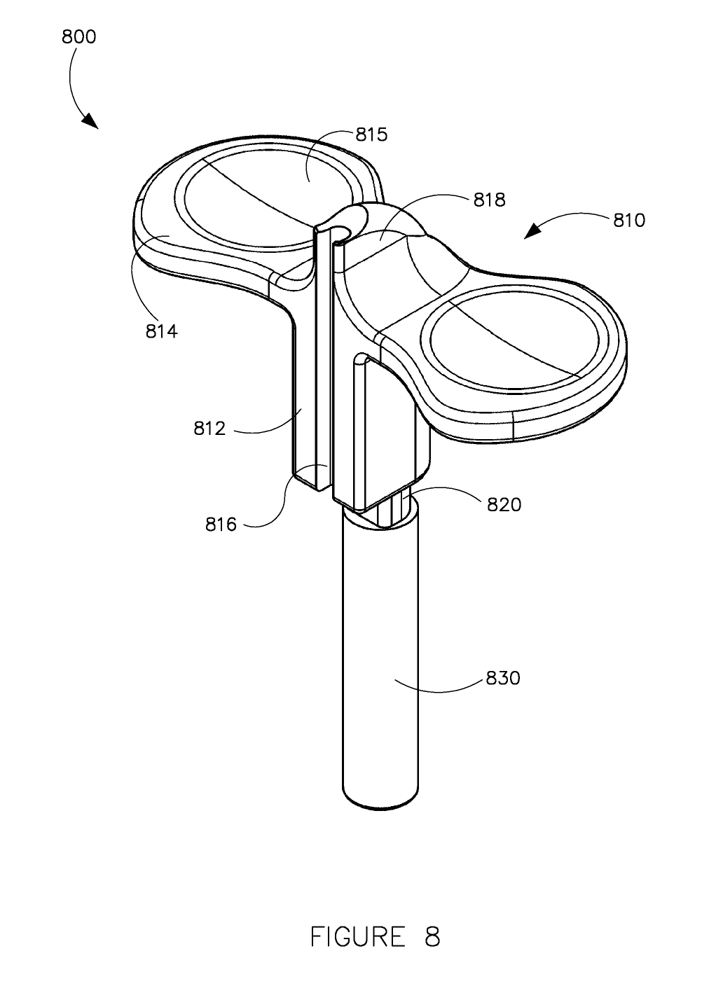

Referring to FIG. 8, plunger 800 is shown according to an exemplary embodiment to include a top portion 810, a middle portion 820, and a bottom portion 830. Top portion 810 includes a body 812 configured to engage passageway 610 and at least one handle 814 configured to receive an actuating force by a user. Handle 814 includes a concavity 815, the concavity configured to receive at least one finger of a user. Top portion 810 further includes a groove 816 located adjacent to first end 510 of transfer member 120. Groove 816 is oriented longitudinally on plunger 800 and is configured to slidably receive a pin shank therein at first end 510 of transfer member 120. A width dimension of groove 816 is less than a diameter of a pin head so that groove 816 slidably engages a pin head. In one embodiment, groove 816 extends onto middle portion 820. In another embodiment, groove 816 extends onto bottom portion 830. Top portion 810 further includes a projection 818 disposed on a top surface of top portion 810. Projection 818 is configured to liftably engage a pin head at the top of groove 816 so that the pin is presented to a user one at a time and to allow a user to easily grasp a pin head. In various embodiments, projection 818 may have a width dimension about a diameter of a pin head or less than a diameter of a pin head, and projection 818 may have sufficient clearance from surrounding objects such that a user may easily see and/or grasp a pin. In an alternate embodiment, the projection may be include a magnet such that the projection is configured to magnetically lift a pin and present the pin to a user.

In the exemplary embodiment shown, bottom portion 830 may have a variety of radial shapes and is configured to slidably engage a spring housing, shown in FIG. 2 as tube 910. Tube 910 is coupled to or disposed on base 900 and may have a variety of radial shapes. In the embodiment shown, tube 910 is formed as part of base 900, and both bottom portion 830 and tube 910 are substantially cylindrical. Tube 910 is configured to support a return mechanism (e.g., spring 840, biased spring, solenoid, etc.). In the embodiment shown, tube 910 includes a top segment and a bottom segment, the bottom segment having a smaller internal diameter than the top segment, such that a top surface of the bottom segment forms a shelf, which supports spring 840. Spring 840 is located at least partially within tube 910. In the embodiment shown, spring 840 coils around bottom portion 830. Alternatively, the spring may be disposed within a hollow bottom portion, or the spring may be supported by a bottom (not shown) of the tube.

Referring further to FIG. 2, plunger 800 is configured to receive a retaining clip, such as spring clip 822, shown according to an exemplary embodiment. As shown, middle portion 820 is configured to receive a spring clip 822, which substantially surrounds middle portion 820. Middle portion 820 may have a variety of radial shapes, such as a substantially “U” or “C” radial shape. In the embodiment shown, middle portion 820 has smaller radial dimension than either top portion 810 or bottom portion 830, such that when spring clip 822 is coupled to middle portion 820, translation of spring clip 822 in relation to plunger 800 in a longitudinal direction is substantially restricted. Spring clip 822 may have a variety of shapes, such as a substantially “U” or “C” shape. Spring clip 822 is intended to couple spring 840 to plunger 800, and spring clip 822 includes a surface against which spring 840 may push, so that spring clip 822 transfers force from the return mechanism to plunger 800.

Referring to FIGS. 2 and 8, according to an exemplary embodiment, plunger 800 is normally spring based to a presenting position (shown in FIG. 1B). A user may depress handle 814 causing a downward translation of plunger 800 and storage of energy in spring 840. Top portion 810 slides past or beneath a pin 101 located at first end 510 of transfer member 120. A head of pin 101 slides along groove 816. When plunger 800 reaches a loading position (shown in FIG. 1A), pin 101 translates from transfer member 120 to plunger 800. In the embodiment shown, when projection 818 is lower than the head of pin 101, gravity causes translation of pin 101 from transfer member 120 to projection 818, such that projection 818 liftably engages pin 101. In one embodiment, a shank of pin 101 is at least partially disposed in groove 816 when pin 101 is liftably engaged by projection 818. As a user releases handle 814, spring 840 urges plunger 800 towards the presenting position. When plunger 800 reaches the presenting position, a user may remove pin 101 from projection 818 and, if desired, begin the process over again. As one of skill in the art will recognize, while it is expected that a user will wait until plunger 800 is in the presenting position to remove pin 101 from dispenser 110, a user may remove pin 101 from dispenser 110 when it is not in the presenting position, directly from delivery mechanism 130, or directly from transfer member 120. In an alternate embodiment, the plunger may be actuated by a motor.

Referring to FIGS. 1B and 7, in the exemplary embodiment shown, dispenser 110 includes a fascia 720 configured to protect internal components of system 100 from a user, and vice versa. Fascia 720 also keeps dust and other debris out of system 100. As shown, fascia 720 is configured to interface with cover 190 and base 900 for continuous protective purposes. According to alternate embodiments, fascia 720 may have a variety of shapes meeting protective, functional, and aesthetic requirements of the manufacturer (e.g., draft angles for molding) and/or user.

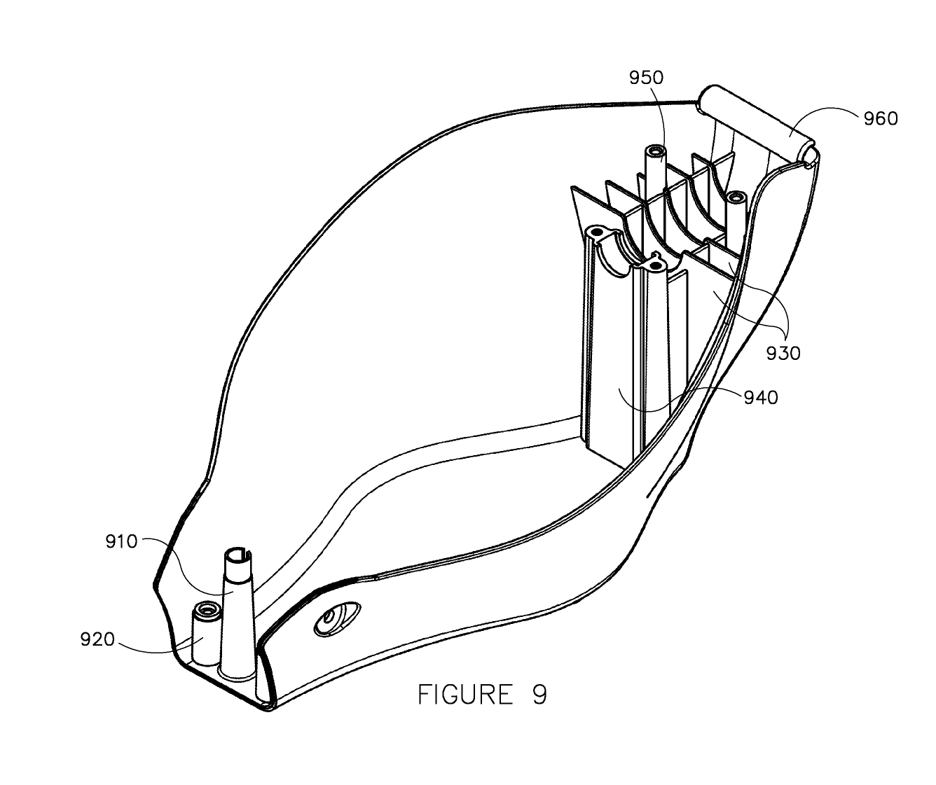

Referring to FIG. 2, an exploded perspective view of system 100, and FIG. 9, a perspective view of base 900, base 900 is shown according to an exemplary embodiment. In various embodiments, base 900 is made of metal, plastic, or other suitable rigid material. In one embodiment, base 900 is made of polypropylene. In another embodiment, base 900 is made of ABS. Base 900 is configured to protect internal components of system 100 from a user, and vice versa. Base 900 also keeps dust and other debris out of system 100. In various embodiments, base 900 has a variety of different shapes and sizes. In the embodiment shown, base 900 has narrower front and rear portions and a wider middle portion, configured to accommodate drum 131 of delivery mechanism 130. In one embodiment, base 900 includes pads or feet located on an underside of base 900 made of rubber, plastic, fabric, or other suitable material to protect and to provide grip of the surface upon which base 900 rests. According to one exemplary embodiment, drum 131 is coupled to base 900 for rotation about an axis, such as axis of rotation 200. In various other embodiments, base 900 supports a combination of dispenser 110, transfer member 120, delivery mechanism 130, drive mechanism 210, and/or cover 190. As shown, base 900 supports cover 190, dispenser 110, which supports transfer member 120, and drive mechanism 210, which supports delivery mechanism 130.

According to the exemplary embodiment shown, a front portion of base 900 includes at least one mount 920 (e.g., tube, stud, boss, etc.) configured to support dispenser 110. In various embodiments, mount 920 has a variety of radial shapes. As shown, mount 920 is cylindrical and formed as a part of base 900. As shown, mount 920 couples to column 710 of dispenser 110. Mount 920 includes a nipple disposed on a top portion of mount 920 which press fits (e.g., interference fit, friction fit, etc.) into a bottom portion of column 710. As shown, base 900 includes tube 910 configured to house spring 840 of dispenser 110. In one embodiment, a top surface of tube 910 is configured to support dispenser 110. In another embodiment, a top surface of tube 910 is configured to stop depression of plunger 800 by contacting a bottom surface of top portion 810 of plunger 800. In yet another embodiment, a top surface of tube 910 is configured to stop depression of plunger 800 by contacting spring clip 822.

According to the exemplary embodiment shown, base 900 is configured to support drive mechanism 210. As shown, a rear portion of base 900 includes at least one brace 930 (e.g., rib, spar, joist, web, flange, etc.), configured to support a motor 220 (discussed more below) and motor mount 240. Brace 930 provides structural rigidity to base 900. As shown, base 900 includes a tower 940 configured to support bearing 250 (discussed more below) and bearing cap 252. As shown, base 900 includes at least one battery mount 950 configured to support and retain battery pack 234. In various embodiments, the brace, the tower, and the battery mount have a variety of shapes, sizes, and configurations. In the embodiment shown, brace 930, tower 940, and battery mount 950 are formed as part of base 900.

According to the exemplary embodiment shown, a rear portion of base 900 is configured to support cover 190 (discussed more below). As shown, base 900 is removably and hingedly coupled to cover 190. The rear portion of base 900 includes a receiver 960 configured to a receive a rod (not shown; e.g., shaft, pin, spindle, stem, etc.) or boss (e.g., studs, posts, etc.) disposed on cover 190. In the embodiment shown, the rod snap fits into receiver 960. Removably or hingedly coupling cover 190 to base 900 provides user access to battery pack 234 and drum 131. Providing user access in this manner facilitates replacing batteries 232 and replenishing pins 101 in drum 131.

According to an exemplary embodiment shown in FIG. 1B, system 100 includes cover 190. As shown, cover 190 is configured to protect internal components of system 100 from dust, debris, liquid, and the like. Additionally, cover 190 protects a user, pets, thread, fabric, and the like from moving and electrical components of system 100. According to alternate embodiments, the cover may have a variety of shapes meeting protective, functional, and aesthetic requirements of the manufacturer and/or user. In the embodiment shown, cover 190 includes a rear section and a front section. The rear section of cover 190 includes a rod or boss configured to snap fit into receiver 960 of base 900. The rear section of cover 190 is configured to accommodate drive mechanism 210 and delivery mechanism 130, particularly drum 131. The front section of cover 190 is configured to accommodate transfer member 120. The front section of cover 190 is further configured to interface with fascia 720 for protective and aesthetic purposes.

Referring to the upper right of FIG. 1A, a perspective view of system 100, and FIG. 2, an exploded perspective view of system 100, drive mechanism 210 is shown according to an exemplary embodiment. In the embodiment shown, drive mechanism 210 includes a motor 220, which is mounted coaxial to axis of rotation 200 and is configured to rotate drum 131 about axis of rotation 200 at a predetermined speed. In alternate embodiments, the motor may be mounted elsewhere and configured to rotate the drum by gears, belts, or other transmission mechanisms known to those of skill in the art. In the embodiment shown, drive mechanism 210 is electrically powered. In various alternate embodiments, the drive mechanism may be manually powered (e.g., crank, handle, wheel, etc.).

In the embodiment shown, drive mechanism 210 includes motor 220, which is electrically coupled to a power source. As shown, the power source is at least one battery 232. In alternate embodiments, the power source is a photovoltaic cell, a utility electric power supply (e.g., wall outlet), etc. As shown, motor 220 includes a motor body 222 and an output shaft 224. Motor body 222 is supported by a cradle formed in brace 930 of base 900. Motor body 222 couples to motor mount 240, which is configured to counter a reaction force experienced by motor 220 resulting from driving delivery mechanism 130. In various embodiments, motor mount 240 couples to motor body 222 by adhesive, a boss engaging a hole, (as shown) a fastener (e.g., rivet, screw, etc.) passing through motor mount 240 into motor body 222, or other means known by those of skill in the art. Motor mount 240 may have a variety of shapes and sizes. In the embodiment shown, motor mount 240 includes a central hole 242 and at least one wing 244, which engages brace 930 to counter the reaction force. Output shaft 224 and driveshaft 440 of drum 131 coaxially pass through central hole 242. As such, output shaft 224 is internal to driveshaft 440. Output shaft 224 may engage driveshaft 440 by splines, press fit, etc. In alternate embodiments, driveshaft 440 is internal to output shaft 224.

According to an exemplary embodiment, system 100 includes a bearing 250 (shown in the middle of FIG. 2). A top surface of tower 940 is configured to receive bearing 250. The top surface of tower 940 is further configured to receive a bearing cap 252, which couples to tower 940 and holds bearing 250 in place. In alternate embodiments, the bearing is press fit into the tower. In the embodiment shown, an internal diameter of bearing 250 receives driveshaft 440 of drum 131. In this manner, bearing 250 supports or carries drum 131 via driveshaft 440, allows drum 131 to rotate about axis of rotation 200, and restricts radial movement of drum 131 and motor 220.

Referring to the upper right portion of FIGS. 1A and 2, an exemplary embodiment of system 100 includes battery pack 234, supported at a rear portion of base 900. Battery pack 234 is configured to support at least one battery 232. In various embodiments, the at least one battery 232 may be a standard size (e.g., AAA, AA, 9-Volt, etc.) or custom size, rechargeable or disposable, or of other types known to those of skill in the art. In one embodiment, battery pack 234 is coupled to base 900. In an alternate embodiment, the battery pack is formed as a part of the base. In the embodiment shown, battery pack 234 includes a rear flange (not shown) which is fastened to battery mount 950 of base 900. As shown, battery pack 234 includes a bottom brace 236 (e.g., rib, spar, joist, web, flange, etc.), which is supported by brace 930 of base 900. Bottom brace 236 is configured to straddle motor body 222. In the embodiment shown, the bottom brace 236 engages a groove in motor body 222. In this manner, battery pack 234 restricts axial translation of drive mechanism 210 and delivery mechanism 130.

According to the exemplary embodiment shown, motor 220 rotates output shaft 224. Output shaft 224 engages driveshaft 440, causing drum 131 to rotate at a rotational speed. Rotation of drum 131 delivers pins to second end 520 of transfer member 120, as described above, which transfers pins 101 to first end 510 of transfer member 120. The rate at which pins are delivered to first end 510 of transfer member 120 is a function of the rotational speed and the number of lugs 360 on drum 131. In one embodiment, the number of lugs and the rotational speed are predetermined such that a pin is delivered to the first end 510 of transfer member 120 at a predetermined rate. In one embodiment, the predetermined rate is less than 1 second per pin. In one embodiment, the predetermined rate is about 1 second per pin. In one embodiment, the predetermine rate is less than 1.5 seconds per pin. In one embodiment, the predetermine rate is less than 2 seconds per pin. In one embodiment, the predetermined rate is between about 1 second per pin and about 1.5 seconds per pin.

According to an exemplary embodiment (not shown), system 100 includes a sensor operable to monitor a condition representative of a minimum desired quantity of pins 101 and a maximum desired quantity of pins 101 loaded onto transfer member 120. The sensor is configured to start motor 220 when the minimum desired quantity of pins 101 is reached, and to stop motor 220 when the maximum desired quantity of pins 101 is reached. In one embodiment, system 100 includes a switch (not shown) operable to start motor 220 when a minimum desired quantity of pins 101 on transfer member 120 is reached, and to stop motor 220 when a maximum desired quantity of pins 101 on transfer member 120 is reached. In one embodiment, a user actuates the switch. In another embodiment, the sensor actuates the switch.

According to another exemplary embodiment (not shown), system 100 includes a vibrating element coupled to at least one of the base 900, the drum 131, the transfer member 120 and the dispenser 110. The vibrating element coupled to drum 131 breaks a static friction between a pin 101 and drum surface 132, thus facilitating translation of a pin 101 toward scoop 364. The vibrating element coupled to transfer member 120 breaks a static friction between a pin 101 and transfer member 120, thus facilitating translation of a pin 101 toward first end 510 of transfer member 120.

According to one exemplary embodiment, a pin dispensing apparatus includes a dispenser configured to present a pin to a user, a transfer member configured to convey the pin to the dispenser, and a delivery mechanism configured provide the pin to the transfer member. In one embodiment, the dispenser is configured to liftably engage a pin. In one embodiment, the transfer member sequentially orders at least one pin, and the dispenser presents the at least one pin one at a time. In one embodiment, the dispenser further includes a presenting position, a loading position, and a return mechanism, the return mechanism configured to urge the dispenser towards the presenting position after the dispenser has been depressed from the presenting position towards the loading position. In one embodiment, the return mechanism includes a biased spring. In one embodiment, the transfer member includes a first end disposed near the dispenser, a second end disposed opposite the first, and a chute disposed substantially between the first and second ends. In one embodiment, the chute is configured to receive a pin shank. In one embodiment, the transfer member is configured to convey a pin from the second end towards the first end at least partially by a gravity feed. In one embodiment, the delivery mechanism includes a housing having at least one sidewall, which defines a cavity and has an end which defines an aperture, and an axis of rotation disposed substantially perpendicular to a plane defined by the aperture, wherein the second end of the transfer member is disposed in the cavity. In one embodiment, the housing further includes at least one protrusion disposed on the sidewall and extending into the cavity. In one embodiment, the at least one protrusion includes an inclined surface configured such that rotation of the housing about the axis of rotation urges axially a pin disposed in the housing. In one embodiment, the housing further includes a larger cross-section and a smaller cross-section, wherein the larger and smaller cross-sections are substantially perpendicular to the axis of rotation. In one embodiment, the housing is substantially cylindrical. One embodiment further includes a drive mechanism configured to rotate the housing about the axis of rotation. In one embodiment, the drive mechanism is mounted coaxial to the axis of rotation. In one embodiment, the drive mechanism is electrically powered.

According to another exemplary embodiment, a pin dispensing apparatus includes at least one transfer member and a dispenser. The at least one transfer member having a first end, second end, and at least one edge, the edge disposed substantially between the first and second ends and defining a chute. The dispenser configured to present a pin to a user and disposed substantially near the first end. The dispenser having an actuator movable between a presenting position and a loading position and configured to liftably engage a pin head. The dispenser further having a return mechanism configured to urge the actuator towards the presenting position. The transfer member is inclined such that a pin head slidably engaged on the at least one edge will gravitationally translate from the second end towards the first end. One embodiment further includes a substantially barrel-shaped housing configured to provide at least one pin to the chute and having at least one sidewall having an end and defining a cavity, the end of the at least one sidewall defining an aperture, an axis of rotation disposed substantially perpendicular to a plane defined by the aperture, and at least one protrusion disposed on the sidewall and extending into the cavity, wherein the at least one protrusion includes a scoop configured to lift a pin head. One embodiment further includes an electrically powered drive mechanism oriented coaxial to the axis of rotation and configured to rotate the housing about the axis of rotation.

According to another exemplary embodiment, a method for manufacturing a pin dispensing apparatus includes providing a dispenser configured to present a pin to a user, providing a transfer member configured to convey the pin to the dispenser, and providing a delivery mechanism configured to provide the pin to the transfer member. In one embodiment, the dispenser is configured to liftably engage a pin. In one embodiment, the transfer member is configured to sequentially order at least one pin, and the dispenser is configured to present the at least one pin one-at-a-time. In one embodiment, the dispenser further includes a presenting position, a loading position, and a return mechanism configured to urge the dispenser towards the presenting position. In one embodiment, the return mechanism includes a biased spring. In one embodiment, the transfer member includes a first end disposed near the dispenser, a second end disposed opposite the first, and a chute disposed substantially between the first and second ends. In one embodiment, the transfer member is configured to convey a pin from the second end towards the first end at least partially by a gravity feed. In one embodiment, the delivery mechanism includes a housing having at least one sidewall, which defines a cavity and has an end that defines an aperture, and an axis of rotation disposed substantially perpendicular to a plane defined by the aperture. In one embodiment, the second end of the transfer member is disposed in the cavity. In one embodiment, the housing further includes at least one protrusion disposed on the sidewall and extending into the cavity. In one embodiment, the at least one protrusion includes an inclined surface configured such that rotation of the housing about the axis of rotation urges axially a pin disposed in the housing. In one embodiment the housing further includes a larger cross-section and a smaller cross-section, both being substantially perpendicular to the axis of rotation. In one embodiment the housing is substantially cylindrical. One embodiment includes providing a drive mechanism configured to rotate the housing about the axis of rotation. One embodiment includes mounting the drive mechanism coaxially to the axis of rotation.

According to another exemplary embodiment, a pin dispensing apparatus includes a base, a drum coupled to the base for rotation about an axis and configured to contain a supply of pins, an elongated transfer member having a first end and a second end, and a dispenser. The second end disposed at least partially within the drum and configured to receive pins from the drum, and the dispenser disposed proximate the first end of the transfer member and configured to receive pins from the transfer member and move the pins to a presenting position. In one embodiment, the second end of the transfer member is disposed within an upper portion of the drum, and the pins move from the second end to the first end at least partially by a gravity feed. In one embodiment, the dispenser includes a spring-biased actuator configured to engage a head portion of the pins for moving the pins to the presenting position. In one embodiment, the pins comprise head portions having a variety of shapes and sizes, and the dispenser is operable to move the pins to the presenting position one-at-a-time. One embodiment further includes a motor configured to rotate the drum at a predetermined speed. In one embodiment, the drum further includes a plurality of protrusions configured to load pins onto the transfer member when the drum is rotated. In one embodiment, the protrusions include an inclined surface. One embodiment further includes a sensor operable to monitor a condition representative of a minimum desired quantity of pins and a maximum desired quantity of pins loaded onto the transfer member, the sensor configured to start the motor when the minimum desired quantity of pins is reached and to stop the motor when the maximum desired quantity of pins is reached. One embodiment further includes a switch operable to start the motor when a minimum desired quantity of pins on the transfer member is reached and to stop the motor when a maximum desired quantity of pins on the transfer member is reached. One embodiment further includes a vibrating element coupled to at least one of the base, the drum, the transfer member and the dispenser.

References herein to “front,” “back,” “rear,” “upper,” “lower,” “right,” and “left” in this description are merely used to identify the various elements as they are oriented in the FIGURES. These terms are not meant to limit the element which they describe, as the various elements may be oriented differently in various applications.

It should further be noted that for purposes of this disclosure, the term coupled means the joining of two members directly or indirectly to one another. Such joining may be stationary in nature or moveable in nature and/or such joining may allow for the flow of fluids, electricity, electrical signals, or other types of signals or communication between the two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

The construction and arrangement of the devices and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting” essentially of will be understood to include those elements specifically recited and those additional elements that do not materially affect the basic and novel characteristics of the claimed technology. The phrase “consisting of” excludes any element not specified.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

1. A pin dispensing apparatus comprising:
a dispenser, the dispenser configured to present a pin to a user;
a transfer member, the transfer member configured to convey the pin to the dispenser; and
a delivery mechanism, the delivery mechanism configured to provide the pin to the transfer member.

2. The apparatus of claim 1, wherein the dispenser is configured to liftably engage a pin.

3. The apparatus of claim 1, wherein the transfer member sequentially orders at least one pin, and the dispenser presents the at least one pin one at a time.

4. The apparatus of claim 1, wherein the dispenser further comprises:
a presenting position;
a loading position; and
a return mechanism, the return mechanism configured to urge the dispenser towards the presenting position after the dispenser has been depressed from the presenting position towards the loading position.

5. The apparatus of claim 4, wherein the return mechanism comprises a biased spring.

6. The apparatus of claim 1, wherein the transfer member comprises:
a first end, the first end disposed near the dispenser;
a second end, the second end disposed opposite the first; and
a chute, the chute disposed substantially between the first and second ends.

7. The apparatus of claim 6, wherein the chute is configured to receive a pin shank.

8. The apparatus of claim 6, wherein the transfer member is configured to convey a pin from the second end towards the first end at least partially by a gravity feed.

9. The apparatus of claim 1, wherein the delivery mechanism comprises a housing having:
at least one sidewall;
the at least one sidewall defining a cavity;
the at least one sidewall having an end;
the end of the at least one sidewall defining an aperture; and
an axis of rotation, the axis of rotation disposed substantially perpendicular to a plane defined by the aperture;
wherein the second end of the transfer member is disposed in the cavity.

10. The apparatus of claim 9, wherein the housing further comprises at least one protrusion, the protrusion disposed on the sidewall and extending into the cavity.

11. The apparatus of claim 10, wherein the at least one protrusion comprises an inclined surface, the inclined surface configured such that rotation of the housing about the axis of rotation urges axially a pin disposed in the housing.

12. The apparatus of claim 9, wherein the housing further comprises:
a larger cross-section; and
a smaller cross-section;
wherein the larger and smaller cross-sections are substantially perpendicular to the axis of rotation.

13. The apparatus of claim 12, wherein the housing is substantially cylindrical.

14. The apparatus of claim 1 further comprising a drive mechanism, the drive mechanism configured to rotate the housing about the axis of rotation.

15. The apparatus of claim 14, wherein the drive mechanism is mounted coaxial to the axis of rotation.

16. The apparatus of claim 14, wherein the drive mechanism is electrically powered.

17. A pin dispensing apparatus comprising:
at least one transfer member having:
a first end;
a second end; and
at least one edge, the edge disposed substantially between the first and second ends and defining a chute; and
a dispenser configured to present a pin to a user and disposed substantially near the first end, the dispenser comprising:
an actuator movable between a presenting position and a loading position, the actuator configured to liftably engage a pin head; and
a return mechanism configured to urge the actuator towards the presenting position;
wherein the transfer member is inclined such that a pin head slidably engaged on the at least one edge will gravitationally translate from the second end towards the first end.

18. The apparatus of claim 17 further comprising a substantially barrel-shaped housing, the housing configured to provide at least one pin to the chute and comprising:
at least one sidewall;
the at least one sidewall defining a cavity;
the at least one sidewall having an end;
the end of the at least one sidewall defining an aperture; and
an axis of rotation, the axis of rotation disposed substantially perpendicular to a plane defined by the aperture; and
at least one protrusion, the protrusion disposed on the sidewall and extending into the cavity;
wherein the at least one protrusion comprises a scoop configured to lift a pin head.

19. The apparatus of claim 18 further comprising an electrically powered drive mechanism, the drive mechanism oriented coaxial to the axis of rotation and configured to rotate the housing about the axis of rotation.

20. A method for manufacturing a pin dispensing apparatus comprising:
providing a dispenser configured to present a pin to a user;
providing a transfer member configured to convey the pin to the dispenser; and
providing a delivery mechanism configured to provide the pin to the transfer member.

21. A pin dispensing apparatus, comprising:
a base;
a drum coupled to the base for rotation about an axis, the drum configured to contain a supply of pins;
an elongated transfer member having a first end and a second end, the second end disposed at least partially within the drum and configured to receive pins from the drum; and
a dispenser disposed proximate the first end of the transfer member and configured to receive pins from the transfer member and move the pins to a presenting position.

22. The apparatus of claim 21, wherein the second end of the transfer member is disposed within an upper portion of the drum, and the pins move from the second end to the first end at least partially by a gravity feed.

23. The apparatus of claim 21, wherein the dispenser comprises a spring-biased actuator configured to engage a head portion of the pins for moving the pins to the presenting position.

24. The apparatus of claim 21, wherein the pins comprise head portions having a variety of shapes and sizes, and the dispenser is operable to move the pins to the presenting position one-at-a-time.

25. The apparatus of claim 21 further comprising a motor configured to rotate the drum at a predetermined speed.

26. The apparatus of claim 21, wherein the drum further comprises a plurality of protrusions configured to load pins onto the transfer member when the drum is rotated.

27. The apparatus of claim 21, wherein the protrusions comprise an inclined surface.

28. The apparatus of claim 21 further comprising a sensor operable to monitor a condition representative of a minimum desired quantity of pins and a maximum desired quantity of pins loaded onto the transfer member, the sensor configured to start the motor when the minimum desired quantity of pins is reached, and to stop the motor when the maximum desired quantity of pins is reached.

29. The apparatus of claim 21 further comprising a switch operable to start the motor when a minimum desired quantity of pins on the transfer member is reached, and to stop the motor when a maximum desired quantity of pins on the transfer member is reached.

30. The apparatus of claim 21 further comprising a vibrating element coupled to at least one of the base, the drum, the transfer member and the dispenser.
